(19) United States
(12) Patent Application Publication
(10) Pub. No.: US 2021/0171395 A1
(43) Pub. Date: Jun. 10, 2021

(54) LIGHT MINERAL ORGANIC INSULATION

(71) Applicant: Jaime Alonso Chavez Medina, Tijuana (MX)

(72) Inventor: Jaime Alonso Chavez Medina, Tijuana (MX)

(21) Appl. No.: 17/114,635

(22) Filed: Dec. 8, 2020

(30) Foreign Application Priority Data
Dec. 10, 2019 (MX) MX/U/2019/00635

(51) Int. Cl. C04B 18/24; B09B 3/00; E04B 1/80

(52) U.S. Cl. CPC C04B 18/24; B09B 3/0041; E04B 2001/745; C04B 2201/30; E04B 1/80

(57) ABSTRACT

The summary of the utility model describes a light mineral organic insulation product that is characterized by the modification of elements found in nature and the environment which, through the process described above, lead us to obtain this insulation which Due to its characteristics and composition of the elements described and its great advantages in the use of resources that are polluting to the environment, it will generate a great impact in the construction industry because, among other advantages, costs are considerably reduced, as well as the times of installation which will optimize human resources saving man-hours because its installation is extremely simple and the materials are light and manageable.

This isolation aims to strongly promote a new generation of less aggressive proposals for the planet that will have repercussions for the benefit of future generations.

### TECHNICAL FIELD OF THE INVENTION

The present invention is directly related to the field of construction, the design of structures, architecture, renewable resources and recycling of organic and inorganic materials, since it provides an insulation system made of these materials

### BACKGROUND OF THE INVENTION

In all house and building construction activities it is necessary to use walls that have already been manufactured on site or prefabricated.

While it is true there are different types of insulators on the market that can be used to build walls of different dimensions and materials such as fiberglass, wool mineral cork, cellulose, basalt wool, textile wool, polystyrene expanded pearl, among others.

The prefabrication of the insulation allows it to be easy to move and a simple assembly that allows the materials used in its prefabrication to generate less polluting waste.

The prefabrication of construction elements can represent in the performance of the work greater agility in construction, more performance in working hours, improvements to the environmental impact by not generating pollutants.

In recent decades, recycling has been considered an important element in environmental impact issues, many of the elements that we find in nature or as Organic waste can be reused and generate environmental impact changes, many of these elements end their life in sanitary landfills, thus contaminating the soil and subsoil.

Several studies have managed to develop construction materials that use mostly plastic waste, which contributes to the non-contamination of the environment, made in such a way that they have great mechanical resistance and contribute to light and sustainable constructions.

The problem of rising housing prices worldwide can benefit from the construction of cheap and quality housing, this with the use of recycled elements found in nature or the environment.

The raw material that we use for our Light Mineral Organic Insulation, we can find them easily because we find them scattered in nature or in the environment with which we can ensure the supply of raw material.

The manufacturing processes that we carry out are very simple, which means that no environmental pollutants are generated at the time of the production of Light Mineral Organic Insulation.

In the process of making the Insulator we use materials that are found in nature and it is in the state that they are found that they will be reused, in addition to this the inorganic raw material is obtained from recycling companies of plastic materials of which we find permanent supply due to the high levels of plastic waste generation in the environment.

Light mineral organic insulation is a product that can be used to insulate walls and ceilings in various shapes and dimensions, adaptable to any size and shape required.

With the use of recycled materials, it is possible to obtain economic benefits for construction companies, which will see the benefits of the use of this insulation reflected from the consumption of man-hours because it is light and easy to install, as well as not representing a risk due to its weight. moment of transfers and assembly of the insulation.

The use of Light Mineral Organic Insulation can be used in all construction sectors because its benefits in terms of resistance, cold or heat thermal capacity are regulated through insulation, within the characteristics stated the resistance conditions we can mention that this product Due to its processing characteristics, it offers high resistance to fire, thus anticipating human and economic losses in areas that are exposed to fire risk conditions, such as residential areas near fields and pastures, as well as populations in general.

Any construction that is going to be used to protect people can benefit from our product.

At present there are various types of insulating materials on the construction market. A search was carried out for patents and / or utility models similar to the one that I present, finding that there are currently different types of insulators for construction, but none of them with the characteristics of the raw material that is used in the Light Mineral Organic Insulation that is presented in this application.

There is a Utility Model with CIP classification number E04B2/18 (2006-01) with publication date May 31, 2016 called “INSULATING BLOCK FOR CONSTRUCTIONS” that describes an insulating block for construction that comprises a central core of insulating material that has an upper face, a lower face, a front face, a rear face and two side faces; two lateral sections of non-insulating material adjoin and fixed to the lateral faces of the central core, thus forming a substantially rectangular unitary body, which defines an upper face, a lower face, a front face, a rear face and two lateral faces; said lateral sections are separated by the central heart so that heat transfer between them is avoided.

None of the documents found describes an insulator for construction similar to the one presented in this document, since the physical and material characteristics are totally different from those that have records

It is observed that the model found refers to the composition of insulating blocks, but none refers to an insulation that will be placed inside the walls or ceilings of the construction, such as Light Mineral Organic Insulator.

### Brief Synthesis of the Invention

With the aim of obtaining the rational use of available resources instead of burying, burning or accumulating them, the product represents a possibility of eliminating pollutants from the environment by developing this sustainable technology. The light mineral organic insulation system achieves protected buildings with a product of affordable cost, speed in installation, flexibility in its materials, certified quality that provides care for the environment and that can be installed in any part of the country regardless of weather conditions. topographic or geographic.

It is therefore Object of the Invention to provide a thermal insulation system with high energy performance, high resistance to fire, high resistance to extreme climates that can be incorporated into the ground without affecting the system.

### Object of the Invention

The purpose of this utility model is to provide a new LIGHTWEIGHT MINERAL ORGANIC INSULATION that, in addition to providing the construction industry for its great thermal and insulating advantages, the use of resources found in nature and recycling materials will generate a great impact on the environment.

### BRIEF DESCRIPTION OF THE DRAWINGS

Characteristics of my insulation are extremely simple, as can be seen in the drawings that follow, the test carried out gives us an element in which the effectiveness of joining them is proven. The figures shown are examples of the materials and should not be considered as limiting for this utility model.

FIG. 1 This figure shows representative elements found in nature such as dry leaves, grass, wood, bark and all those elements that are found in their natural state in green areas.

FIG. 2 This figure shows waste materials that can be recycled in the process of this model, which must be derived from paper such as cardboard, newspaper, magazines, cardboard packaging and all materials that can be recycled, excluding plastics.

FIG. 3 This figure shows a water-based binder agent which is what will give the agglomerate of the materials to form the LIGHT MINERAL ORGANIC INSULATION.

FIG. 4 this figure shows the LIGHT MINERAL ORGANIC INSULATION once the crushing, mixing and compaction processes were carried out

### DETAILED DESCRIPTION OF THE INVENTION

Light mineral organic insulation is a product that can be used to insulate walls and ceilings in various forms such as panels or plates of different dimensions and with different densities depending on your application, it can be used to manufacture lightweight structural walls or bulk fill in cavities or prefabricated, metal or wooden construction spaces

The invention is an insulating product comprising custom made panels that form an insulating and thermal barrier on walls and ceilings. The advantages of this insulation is an integrated mixture of raw materials that exist in abundance in nature as well as an important recovery of recycling materials that contain natural fibers that, even when processed all together and agglomerated with a minimum of binder, we have a very low product environmental impact resistant to direct fire and extreme cold conditions that provides high performance comfort.

### Preferred Realization of Utility Model

Referring to the illustrations to carry out the realization of this utility model I explain in a simple way the process

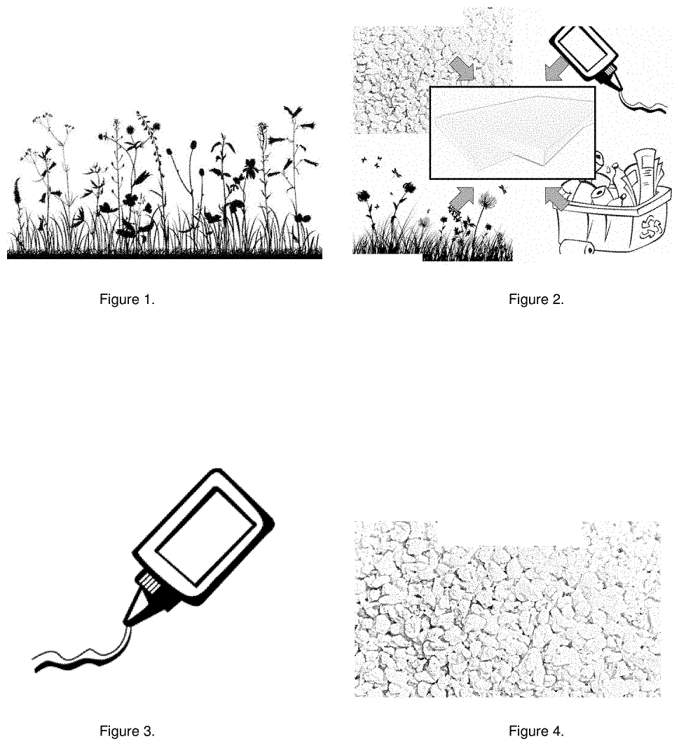

With reference to FIGS. 1, 2, 3 and 4 we will detail the following steps:

A) Collection of waste found in nature

B) Collection of recycling materials composed of natural fibers (paper, cardboard, and their derivatives)

C) Mix of both materials, with a light water-based binder

D) Pressing and compacting the materials

The utility model is described in a simple way in such a way that it can be manufactured by anyone with knowledge in the field and obtain results similar to ours, the technique that corresponds to this utility model may be capable of making modifications that are not described in the present application, however, in the manufacturing process of the same, the following claims require the claimed matter.

We claim:

1. A constructive panel with insulation properties characterized by: a) being reconstituted from light mineral organic Insulation material; and b) such light mineral organic Insulation material being the recovery of products found in nature or being recycled of inorganic garbage that has natural fiber content.

2. A process for obtaining the constructive panel of claim 1, comprising: a) submitting all inorganic elements of the light mineral organic Insulation material through a grinding process; b) integrating all grinding elements obtained thereof with recovered or treated water until reaching their cellular level; c) by performing previous steps, obtaining a smooth paste; and d) once obtained such paste, adding a water-based binder agent.
